(19) United States
(12) Patent Application Publication
(10) Pub. No.: US 2025/0060239 A1
(43) Pub. Date: Feb. 20, 2025

(54) CONTROL SYSTEM AND METHOD FOR A BULK PRODUCT WEIGHING SYSTEM

(71) Applicant: ILLINOIS TOOL WORKS INC., Glenview, IL (US)

(72) Inventor: Kevin CARTWRIGHT, Halesowen (GB)

(21) Appl. No.: 18/807,357

(22) Filed: Aug. 16, 2024

(30) Foreign Application Priority Data
Aug. 17, 2023 (GB) 2312571.9

(51) Int. Cl. G01G 13/24; G01G 23/18

(52) U.S. Cl. CPC G01G 13/24; G01G 23/18

(57) ABSTRACT

A control system includes one or more processors and at least one memory device configured to store product data including information associated with a bulk product and a corresponding bulk product dispenser for the product. The control system is configured to: receive, from a sensor associated with the bulk product dispenser, a detection signal indicative of a dispensing event being detected at the bulk product dispenser; identify the bulk product corresponding to the bulk product dispenser in dependence on the product data; output a control signal to control a display device of the weighing system to display an indication of the bulk product; and in dependence on a threshold expiry time period elapsing since detection of the dispensing event, output a control signal to the display device to remove the indication of the bulk product. A related bulk product weighing system and method are also described.

### TECHNICAL FIELD

This invention relates to a control system, to a bulk product weighing system, and to a computer-implemented method.

### BACKGROUND

In order to reduce packaging waste, retailers are increasingly providing products using bulk product weighing systems. Bulk product weighing systems include a dispenser comprising a hopper or other container for storing a loose product in bulk quantity. A customer operates the dispenser to dispense a desired quantity of product into a container, and weighs the dispensed product at a scale to produce a label for scanning at a point of sale. In this way the customer can re-use containers to reduce packaging waste, and can select a bespoke quantity of product for purchase.

It may be desired to detect dispensing events, i.e., detect each time a dispenser is operated to monitor the number of expected transactions for the product, in order to predict which products will be weighed next to improve the customer experience at the scale.

Such monitoring is associated with a number of issues. In some instances, a customer may actuate a dispenser more than once whilst filling a single container, which can cause an overestimate in the number of expected transactions. In other instances, a customer may deliberately or accidentally actuate a dispenser without intending to purchase the product. Thus, the predicted products at the scale may be inaccurate.

Examples disclosed herein may address one or more of the above problems.

### SUMMARY

In accordance with the present inventions there is provided a control system, a bulk product weighing system and a computer-implemented method as claimed in the appended claims.

According to a first aspect there is provided a control system for a bulk product weighing system, the control system comprising: one or more processors; at least one memory device configured to store product data, the product data comprising information associated with a bulk product and a corresponding bulk product dispenser for the product; wherein the control system is configured to: receive, from a sensor associated with the bulk product dispenser, a detection signal indicative of a dispensing event being detected at the bulk product dispenser; identify the bulk product corresponding to the bulk product dispenser in dependence on the product data; output a control signal to control a display device of the weighing system to display an indication of the bulk product; and in dependence on a threshold expiry time period elapsing since detection of the dispensing event, output a control signal to the display device to remove the indication of the bulk product. Advantageously, a customer using the weighing event is provided with an easy selection of the product which has just been weighed, and dispensing events which have not been weighed in time (due to loss or erroneous counting) are discarded after a threshold time to avoid the display device being overcrowded with irrelevant products.

The control system may be configured to: receive, from a user input device associated with the weighing system, a weighing request for the bulk product; output a control signal to control a weighing apparatus of the weighing system to weigh the bulk product; and in dependence on the weighing of the bulk product, output a control signal to the display device to remove the indication of the bulk product.

Optionally, the control system is configured to store a dispense counter indicative of a number of dispensing events for the bulk product detected within a preceding window corresponding to the threshold expiry time period.

The control system may be configured to: receive, from the sensor associated with the bulk product dispenser, a further detection signal indicative of a further dispensing event being detected at the bulk product dispenser; and increment the dispense counter in dependence on receiving the further detection signal. In this way, the control system can track multiple dispensing events for a single product simultaneously.

The control system may be configured to: determine whether a time between the detection of the further dispensing event and the detection of a preceding dispensing event at the bulk product dispenser is less than an event threshold time; and if the time is determined to be less than the event threshold time, suppress the incrementation of the dispense counter. Advantageously, the control system can account for the sensor being actuated multiple times by a single customer filling a single container without erroneously classifying this as multiple dispensing events. The event threshold time may be less than five seconds. For example, the event threshold time may be 2s, 3s or 4s.

Optionally, the control system is configured to: start a respective expiry timer in dependence on receiving each further detection signal; and in dependence on each respective expiry timer reaching the threshold expiry time, decrement the dispense counter. In this way, the control system can track multiple dispensing events for a single product simultaneously.

The control system may be further configured to decrement the dispense counter in dependence on each weighing of the bulk product by a weighing apparatus of the weighing system.

The control system may configured to retain the indication of the bulk product displayed on the display device if the dispense counter is non-zero. Thus, the product is displayed on the screen whilst there are any outstanding dispensing events for the product within the preceding threshold expiry time.

Optionally, the product data comprises a loss counter indicative of a number of non-weighed dispense events for the product; and the control system is configured to increment the loss counter in response to the threshold expiry time period elapsing since detection of the dispensing event without the product being weighed. Advantageously, this enables the retailer to automatically monitor the number of losses at each dispenser and take appropriate action.

Optionally, the display device is a user interface, and the indication of the bulk product comprises an icon for selection of the bulk product at the display device.

Optionally, the threshold expiry time is between 5 minutes and 60 minutes. For example, the threshold expiry time may be 30 minutes, 20 minutes or 40 minutes. In some examples, the control system is configured to receive a selection signal indicative of a user input for selecting the threshold expiry time, and adjust the threshold expiry time in dependence on the selection signal. Advantageously, this enables the threshold expiry time to be tailored appropriately to differently sized retailers.

According to another aspect, there is provided a bulk product weighing system, the bulk product weighing system comprising: a control system as disclosed herein; a bulk product dispenser arranged to store and dispense a bulk product; a sensor arranged to detect a dispensing event at the bulk product dispenser; a weighing apparatus configured to weigh the dispensed bulk product; and a display device associated with the weighing apparatus arranged to display an indication of the bulk product to a user in dependence on the detection of the dispensing event by the sensor.

According to another aspect, there is provided a computer-implemented method for controlling a bulk product weighing system, the method comprising: storing product data, the product data comprising information associated with a bulk product and a corresponding bulk product dispenser for the product; receiving, from a sensor associated with the bulk product dispenser, a detection signal indicative of a dispensing event being detected at the bulk product dispenser; identifying the bulk product corresponding to the bulk product dispenser in dependence on the product data; controlling a display device of the weighing system to display an indication of the bulk product; and in dependence on a threshold expiry time period elapsing since detection of the dispensing event, controlling the display device to remove the indication of the bulk product.

### BRIEF DESCRIPTION OF THE DRAWINGS

Embodiments of the invention are further described hereinafter with reference to the accompanying drawings, in which:

FIG. 1 is a schematic illustration of a bulk product weighing system according to an embodiment;

FIG. 2 is a schematic illustration of a control system 2000 according to an embodiment;

FIG. 3 illustrates example product data 310, 320;

FIG. 4 shows a flow chart of a method 400 according to an embodiment;

FIG. 5 shows a flow chart of a method 500 according to an embodiment;

FIG. 6 illustrates example product data 610, 620; and

FIGS. 7A to 7C illustrate displayed screens on a display device over time according to a worked example.

### DETAILED DESCRIPTION

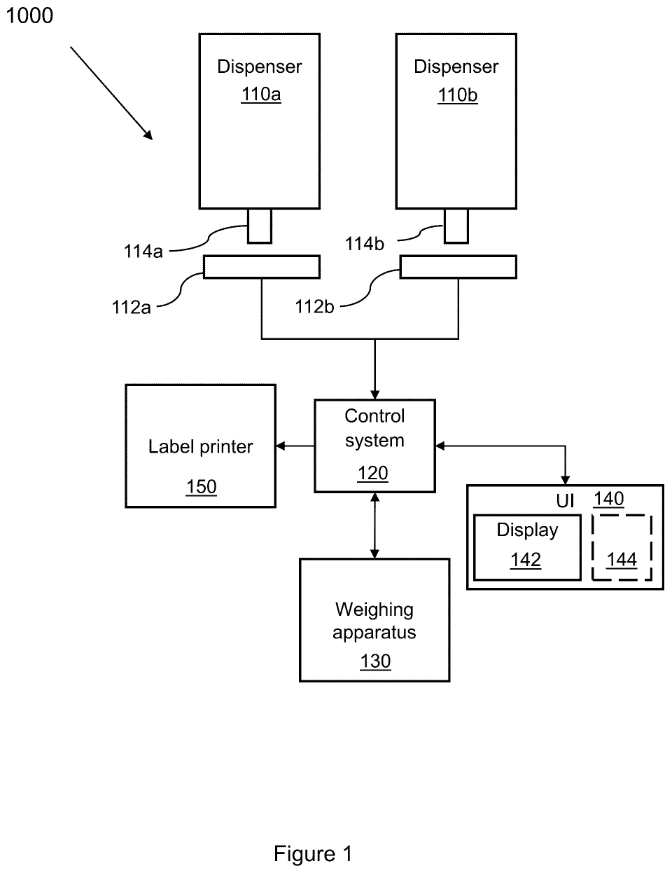

Examples disclosed herein relate to a bulk product weighing system. With reference to FIG. 1, there is shown a schematic illustration of a bulk product weighing system 1000 according to an embodiment of the invention. The bulk product weighing system 1000 is typically disposed in a retail environment, such as a supermarket or the like, where a retailer may facilitate bulk or loose purchase of goods.

The bulk product weighing system 1000 comprises one or more bulk product dispensers 110a, 110b. The illustrated system 1000 comprises two dispensers 110a, 110b, however in other embodiments the system 1000 may only comprise one dispenser 110a, or may comprise additional dispensers.

Each bulk product dispenser 110a, 110b is arranged to store a bulk product and dispense the bulk product to customers. For example, the bulk product hopper 110a, 110b may be arranged to store a bulk food product such as grain, pasta, coffee or the like. The bulk product dispenser 110a, 110b may be used to store any product which can be dispensed and sold per unit weight in the retail environment. Typically, a respective dispenser 110a, 110b will be provided for each bulk product type sold by the retailer.

The bulk product dispenser 110a, 110b comprises a dispensing spout 114a, 114b and an actuator (not shown) such as a handle, button or the like. In use, a customer actuates the actuator, for example by pulling down a handle, which causes the dispensing spout 114a, 114b of the dispenser to open and dispense the product contained in the dispenser 110a, 110b. The customer can select when to stop dispensing the product, for example by releasing the actuator, which causes the dispensing spout 114a, 114b to close and the flow of product to stop.

The system 1000 comprises a weighing apparatus 130 for weighing the dispensed product. The weighing apparatus 130 comprises a scale, such as a digital load cell or other weighing mechanism for measuring a weight of the dispensed product.

The system 1000 further comprises a user interface, UI 140 associated with the weighing apparatus 130. The UI 140 includes a display device 142 for displaying product information to the user. In some embodiments, the UI 140 may also include an input device 144 for receiving a user input from a customer indicative of a selected product. The input device 144 may be a keypad, touch screen or the like. In some embodiments, the input device is integrated with the display device 142, for example as a touch screen display device 142. Once a customer has dispensed a product from the dispenser 110a, 110b, they may bring the dispensed product to the weighing apparatus 130 to be weighed. The customer can control the weighing apparatus through the UI 140 by selecting the product type at the UI 140 and weigh the dispensed product on the weighing apparatus 130. The system 1000 further may comprise a printer 150 for printing a label indicating the type of product, weight and price for scanning at a point of sale.

To improve the customer experience at the bulk product weighing system 1000, it can be desirable for the system to be able to predict which product will be weighed next by a customer. In this way, the display device 142 can pre-emptively display the predicted product for selection by the customer at the UI 140. This may be particularly advantageous in a large retail environment having a large number of products and thus a large number of dispensers 110a, 110b in the bulk product weighing system 1000, which requires the customer to search through a large number of product types at the UI 140. To achieve this, the bulk product weighing system 1000 is configured to detect each time a dispensing event occurs at each dispenser 110a, 110b, and communicate this information to the UI 140.

In order to facilitate the detection of dispensing events, the bulk product weighing system 1000 comprises a sensor 112a, 112b associated with each bulk product dispenser 110a, 110b. Each sensor 112a, 112b is arranged to detect a dispensing event at the bulk product dispenser 110a, 110b. For example, the sensor 112a, 112b may be arranged to sense actuation of a handle of the dispenser 110a, or detect a flow of product from the spout 114a, 114b of the respective dispenser 110a, 110b.

The bulk product weighing system 1000 comprises a control system 120 configured to receive data from each sensor 112a, 112b indicative of each time a dispensing event is detected.

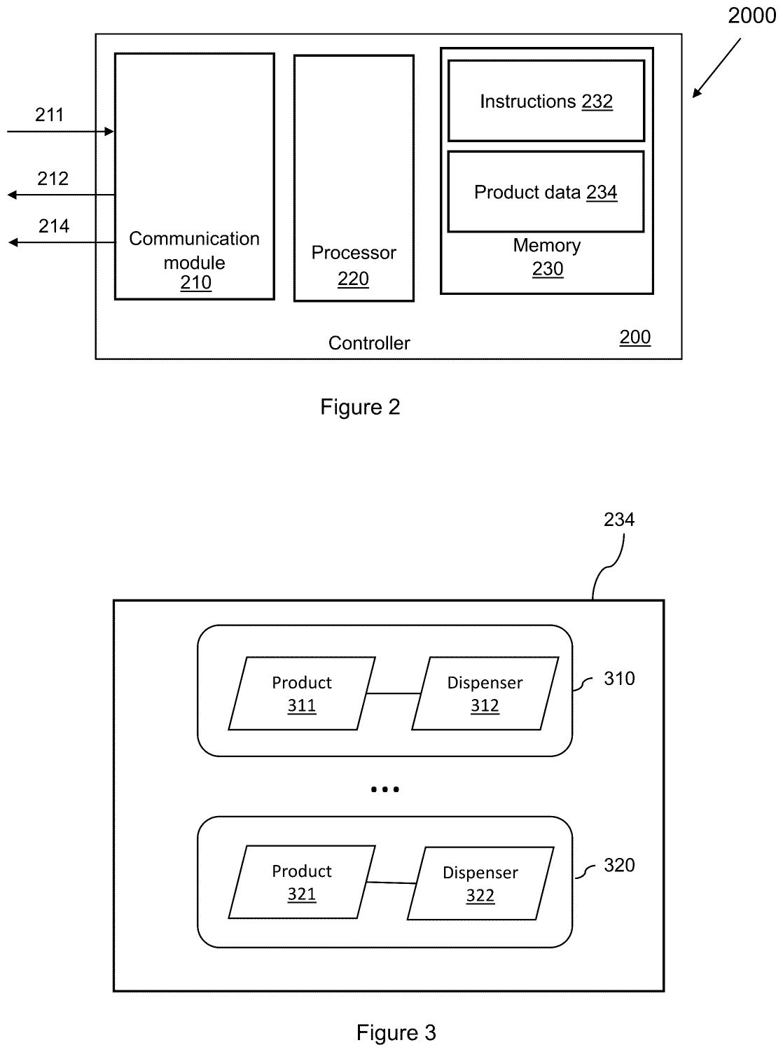

Turning to FIG. 2, there is shown a schematic illustration of a control system 2000 according to an embodiment. The control system 2000 may correspond to the control system 120 shown in FIG. 1, and thus may form part of the bulk weighing system 1000.

The control system 2000 comprises at least one control module, or controller 200. In the illustrated embodiment the control system comprises a single controller 200, however in other embodiments the control system may comprise a plurality of controllers 200 which may be distributed about the bulk weighing system 1000. Each controller 200 of the control system may be communicatively coupled. The connection may be via a wired connection or wirelessly via one or more networks, such as a local area network (LAN) in-store or the Internet. Thus, whilst the function of the control system will be described with reference to a single controller 200, this functionality may be distributed amongst a plurality of controllers 200 in any suitable fashion. In some embodiments, the controller 200 may be disposed locally to the weighing apparatus 130, however in other embodiments the controller 200 may be partially or fully remote.

The controller 200 comprises at least one processor 220, a communication module 210 and a memory 230.

The memory 230 may comprise one or more memory devices, which may be disposed locally to the controller 200, remotely to the controller 200, or a combination. In the case of a remotely located memory device 230, the memory device may be wirelessly communicable with the processor 220 of the controller 210.

The memory 230 is configured to store product data 234. Turning to FIG. 3, the product data 234 may comprise respective product data 310, 320 for each type of bulk product dispensed within the bulk product weighing system 1000. Each product data 310, 320 comprises product information 311, 321 associated with a bulk product and dispenser information 312, 322 identifying a corresponding bulk product dispenser for the product. The product information 311, 321 may include one or more of: a product name, a product identifier, price information such as a price per weight, and a product image. The dispenser information 312, 321 comprises information identifying the bulk product dispenser within the system 1000 which is arranged to dispense the product. The dispenser information 312, 321 may be an identifier of the dispenser 110a, 110b, or an identifier of the associated sensor 112a, 112b.

For example, in the illustrated example, the memory 230 stores first product data 310 associated with a first product stored in the first dispenser 110a. The first product data 310 comprises first product information 311. For example the first product information 311 may include the following:

| | |
|---|---|
| Product type | Fusilli pasta |
| Product identifier | 462823 |
| Price per kg | £1.00 |
| Product image | Fusilli.jpg |

The first product data 310 further comprises first dispenser information 312 such as an identifier for the sensor 112a associated with the first dispenser 110a.

The memory 230 further stores second product data 320 associated with a second product stored in the second dispenser 110b. The second product data 320 comprises second product information 321. For example the second product information 321 may include the following:

| | |
|---|---|
| Product type | Coffee beans |
| Product identifier | 362826 |
| Price per kg | £5.00 |
| Product image | Coffee.jpg |

The second product data 320 further comprises second dispenser information 322 including an identifier for the sensor 112b associated with the second dispenser 110b.

The product data 234 may include further product data corresponding to each additional product within the system 1000, if the system 1000 comprises additional dispensers to the two shown in FIG. 1.

Returning to FIG. 2, the processor 220 is arranged to perform a method according to instructions 232 stored in the memory 230. The communication module 210 is configured to communicate with each sensor 112a, 112b, the weighing apparatus 130 and the UI 140. The communication module 210 may comprise electrical connections for connecting to the components of the system 1000 via a wired connection, and/or may comprise hardware for performing wireless communication such as Wi-Fi, Bluetooth or the like.

The communication module 210 is arranged to receive a detection signal 211 from the or each sensor 112a, 112b. The detection signal 211 is indicative of a dispensing event being detected at the bulk product dispenser 110a, 110b associated with the sensor 112a, 112b. The detection signal 211 further comprises information identifying the bulk product dispenser 110a, 110b such as an identifier of the sensor 112a, 112b.

The controller 200 is then configured to identify the bulk product corresponding to the bulk product dispenser 110a, 110b in dependence on the product data 234. That is, the controller 200 uses the identifier of the sensor 112a, 112b to look up the product information 311, 321 corresponding to that dispenser in the product data 234.

The communication module 210 is then configured to output a first control signal 212 to control the display device 142 to display an indication of the identified bulk product, such as a product image stored in the product data 234, to enable a customer to easily select the relevant product at the UI 140. The indication may comprise an icon for selection at the UI 140. The customer typically then provides an input at the UI 140 to request to weigh the dispensed product, e.g. by selecting the icon of the identified bulk product on the display device 142. A weighing request is communicated from the UI 140 to the control system 120. The control system 120 then outputs a weighing control signal to control the weighing apparatus 130 to weigh the product. Responsive to the weighing of the product, the control system 120 outputs a second control signal 214 to the display device 142 to remove the indication of the bulk product.

However, in some circumstances, the customer will not subsequently select the product at the UI 140 for weighing. This may be the case if the dispensing event was accidental, or in the case of deliberate theft. Leaving the indication of each identified bulk product on the display device 142 may then cause the display device 142 to become crowded with non-weighed products, negating the benefit of enabling the customer to easily find the most recently weighed goods. The controller 200 is therefore configured to monitor a time period elapsed since detection of the dispensing event, e.g. a time period elapsed since the detection signal 211 was received from the sensor 112a, 112b. If a threshold expiry time period elapses without the product being weighed, the communication module 210 is configured to output the second control signal 214 to the display device 142 to remove the indication of the identified bulk product.

The threshold expiry time may be adjusted depending on the requirements of the retailer. For example, for a large store with a large number of dispensers 110a, 110b in the system 1000, a larger threshold expiry time may be appropriate than for a small store with a small number of dispensers. This is because a customer may be dispensing multiple products and an average time taken between dispensing and weighing may be larger for a larger store. In some embodiments the controller 200 may receive a selection signal indicative of a user input for selecting the threshold expiry time, and adjust the threshold expiry time stored in the memory 230 in dependence on the user selection. For a typical store for example, the threshold expiry time may be set to between 5 minutes and 60 minutes, such as 30 minutes, 20 minutes or 40 minutes.

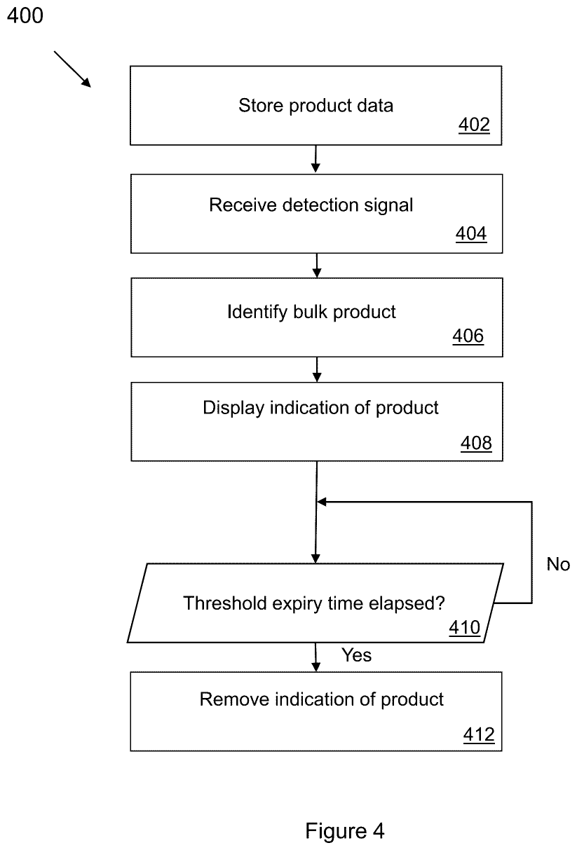

FIG. 4 illustrates a method 400 according to one embodiment. The method 400 may be performed by the control system 120, 2000.

In block 402, the control system 120 stores the product data 234 in the memory 230. In block 404, the detection signal 211 is received from a sensor 112a associated with a bulk product dispenser 110a, the detection signal 211 being indicative of a dispensing event being detected at the dispenser 110a. In block 406, the control system 120 identifies the bulk product corresponding to the dispenser 110a by searching the product data 234. In block 408, the control system 120 outputs the first control signal 212 to control the display device 142 to display an indication of the identified bulk product. In block 410, the control system 120 determines whether the threshold expiry time period has elapsed since detection of the dispensing event. When the threshold expiry time period has elapsed, in block 412 the control system 120 outputs the second control signal 214 to remove the indication of the bulk product from the display device 142.

The control system 120 may receive a respective detection signal 211 each time a dispensing event is detected by any of the sensors 112a, 112b in the system, and store in the memory 230 a dispense counter indicative of a number of outstanding dispensing events detected for each bulk product. A respective dispense counter for the product may therefore be associated with each product data 310, 320. The dispense counter is incremented each time a dispensing event is detected for the product, and decremented each time the product is weighed, or each time the threshold expiry time period elapses for the dispensing event.

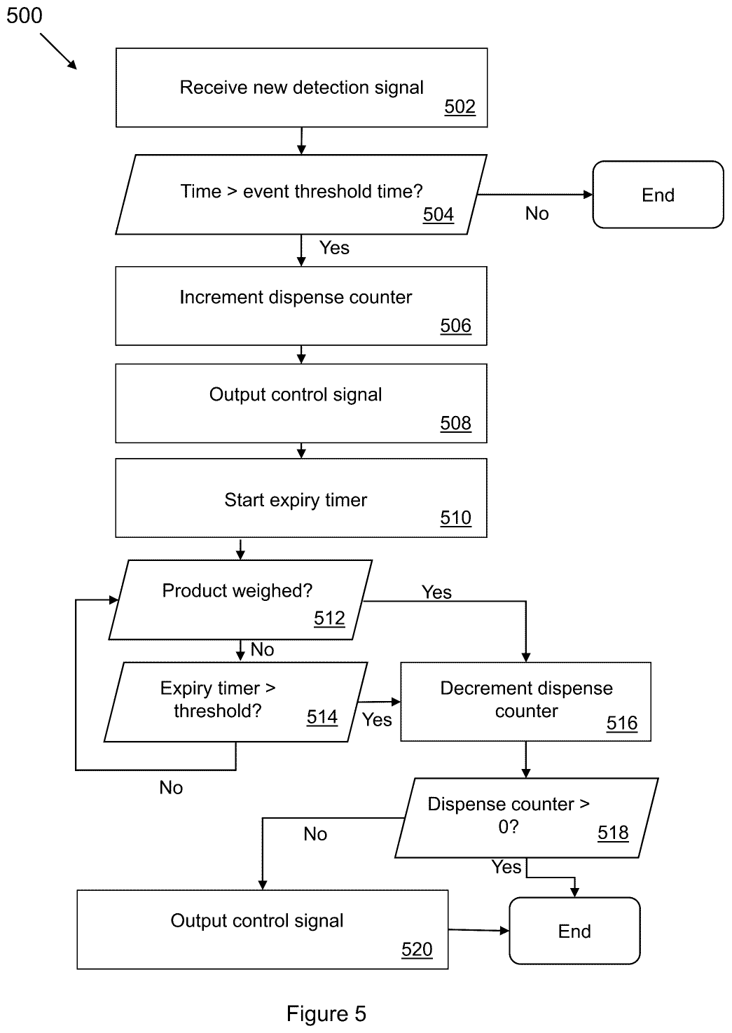

With reference to FIG. 5, there is shown another method 500 according to one embodiment. The controller 200 may be configured to perform the method 500 each time a detection signal 211 is received, e.g. as part of the method 400.

In block 502, a detection signal 211 is received from a sensor 112a, 112b of the system. The detection signal 211 is indicative of a dispensing event being detected, and comprises information identifying the bulk product dispenser 110a, 110b associated with the dispensing event. The controller 200 identifies the bulk product dispenser 110a from the detection signal, and identifies the corresponding product information with reference to the product data 310, 320.

In block 504, the controller 200 determines whether a time between the dispensing event and a preceding dispensing event at the same bulk product dispenser is greater than an event threshold time. The event threshold time may be set to define a time below which the dispensing event is unlikely to be a new event, due to its proximity to the preceding event. For example, the event threshold time may be less than five seconds, such as 2 seconds, 3 seconds or 4 seconds, and may be configurable by the retailer. In one embodiment, the event threshold time is 3 seconds. If the time elapsed between dispensing events at the same dispenser is less than the event threshold time, the method ends and the dispense counter is not incremented for that event. If the time elapsed since the preceding event is greater than the event threshold time, the method proceeds to block 506.

In block 506, the controller 200 increments the dispense counter for the dispensed product. In block 508, the controller 200 may output a first control signal 212 to the display device 142 to display an indication of the dispensed product, if no indication of the dispensed product is currently displayed on the display device 142. In block 510, the controller 200 starts a new expiry timer for the dispensed product. Blocks 506, 508 and 510 may be performed in any order.

When the expiry timer is running, the controller 200 is arranged to determine 512 whether the product has been weighed, i.e., whether a weighing request for the product has been received from the UI 140. The controller 200 is also arranged to determine 514 whether the expiry timer has reached the threshold expiry time. If at any time the product is weighed or the expiry timer reaches the threshold expiry time, the method proceeds to block 516. In block 516, the expiry timer is ended and the dispense counter for the product is decremented.

In block 518, the controller 200 determines whether the dispense counter for the product is non-zero. If the dispense counter for the product is non-zero, this means that another expiry timer is still running for the product. Therefore, the controller 200 retains the indication of the bulk product displayed on the display device 142. If the dispense counter has reached zero, there are no outstanding dispensing events for the product within the threshold expiry time, and the method proceeds to block 520. In block 520, the controller 200 outputs the second control signal 214 to the display device 142 to remove the indication of the product.

Notably, the method 500 can be implemented each time a new detection signal is received from a sensor of the system. Thus, at any one time, multiple expiry timers may be running on the controller 200 for a particular product. This may be the case if a number of customers sequentially use the same dispenser 110a, 110b. Only when all outstanding dispense events for a product have been either weighed or expired does the controller 200 remove the indication of the product from the display device 142.

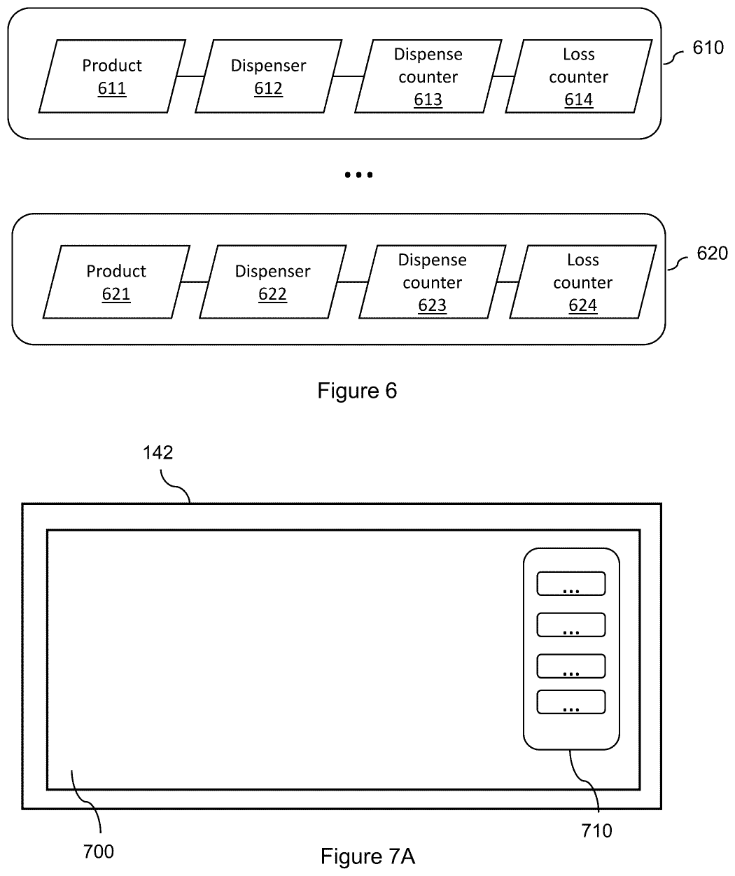

With reference to FIG. 6, there is illustrated example product data 610, 620 according to an embodiment. The product data 610, 620 may form part of the product data 234 stored in the memory 230. The product data 610, 620 comprises at least first product data 610 associated with a first product and second product data 620 associated with a second product.

The product data 610, 620 comprises product information 611, 612 associated with the product and dispenser information 612, 612 indicative of the bulk product dispenser storing the respective product, as previously described with reference to FIG. 3. Each product data 610, 620 also comprises the dispense counter 613, 623 for the respective product as described with reference to FIG. 5.

It may be desirable to monitor product loss within the bulk product weighing system 1000. For that purpose, the product data 610, 620 also comprises a loss counter 614, 624 indicative of a number of non-weighed dispense events for each product. In some embodiments of the method 500, the controller 200 may increment the loss counter 614, 624 of the relevant product if the expiry timer exceeds the threshold in block 514. That is, if the threshold expiry time elapses without the product being weighed, then the controller 200 may determine that the dispensed product will not be purchased and thus a loss has occurred for the product.

The loss counter 614, 616 for each product can be stored in the memory 230 of the control system 2000, or may alternatively or additionally be communicated by the control system 2000 to an external device for monitoring. The loss counter 614, 616 may be used by the retailer to inform decisions about product placement, security and the like. For example, awareness of products associated with a high loss counter can enable retailers to group products together appropriately and add security measures.

In some embodiments, the control system 120, 2000 may monitor the loss counter 614, 624 for each product and automatically alert a user, such as an administrator of the system 1000, if a loss counter 614, 624 exceeds a predefined threshold. The alert may take the form of a notification, alarm or the like communicated by the control system 120, 2000 to a user device of the administrator. The alert may include information such as contained within the product data 610, 620 for the product exceeding the threshold.

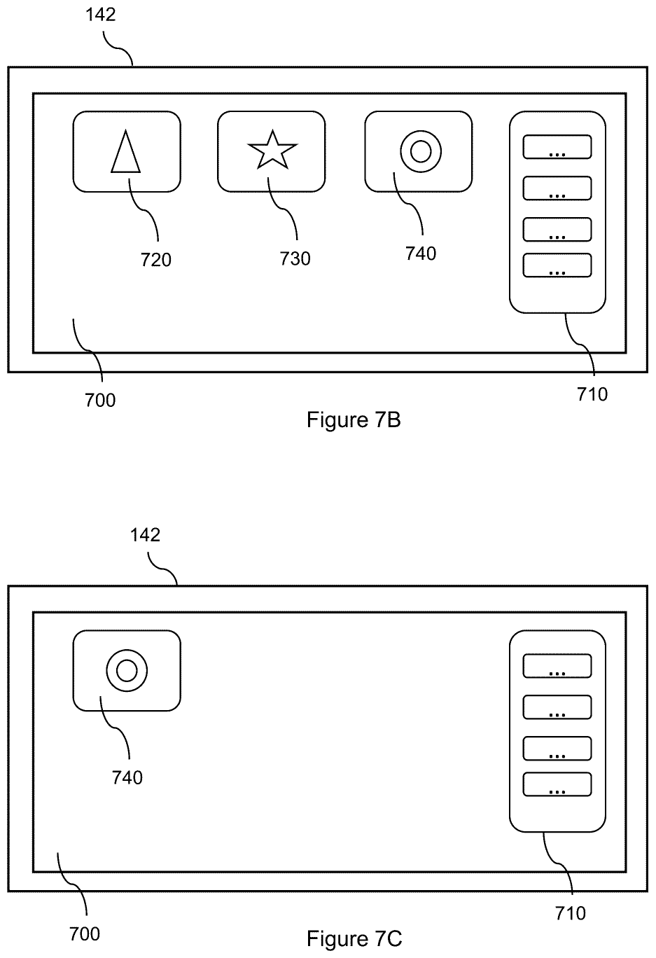

A worked example of the method 400, 500 is described with reference to FIGS. 7A to 7C, which each show a representation of a screen 700 displayed on the display device 142 at three different time points.

The displayed screen 700 includes a menu 710 which may be navigated by a customer to explore the full range of products which may be weighed at the weighing apparatus 130. A customer can therefore search through the menu 710 to identify the product they wish to weigh. However, as discussed, to improve user experience the displayed screen 700 may be adaptively updated to include icons 720, 730, 740 representative of recently dispensed products, to aid the customer in identifying the relevant product.

An example timeline is shown below.

| Time | Event |
|---|---|
| T1 | Customer dispenses item 1, start timer 1 |
| T2 | Customer dispenses item 2, start timer 2 |
| T3 | Customer dispenses item 3, start timer 3 |
| T4 | Customer weighs item 1 |
| T5 | Timer 2 expires |
| T6 | Timer 3 expires |

FIG. 7A shows the displayed screen 700 prior to the first time point T1. No products have been recently dispensed, and thus the screen 700 displays only the menu 710. At time point T1, a customer dispenses item 1 at dispenser 1, and the control system 120 begins expiry timer 1. At time point T2, a customer dispenses item 2 at dispenser 2, and the control system 120 begins expiry timer 2. At time point T3, a customer dispenses item 3 at dispenser 3, and the control system 120 begins expiry timer 3.

FIG. 7B shows the screen 700 between the time points T3 and T4. At this point, three items 1 to 3 have been recently dispensed, and three associated expiry timers are running. The customer has not yet weighed any of the items 1 to 3. The screen 700 therefore displays a first icon 720 of item 1, a second icon 730 of item 2 and a third icon 740 of item 3.

At time T4, the customer weighs item 1 and the first icon 720 is removed from the screen 700. At time T5, timer 2 reaches the threshold expiry time, e.g. 30 minutes have elapsed between time T2 and time T5. Therefore, the system concludes that the dispensing event at time T2 is a loss. The loss counter is incremented for item 2, and the second icon 730 is removed from the screen.

FIG. 7C shows the screen 700 between the time points T5 and T6. At this time, only the third expiry timer is still running, and so only the third icon 740 is displayed on the screen 700. Subsequently, at time T6 timer 3 reaches the threshold expiry time, and the system concludes that the dispensing event at time T3 is a loss. The loss counter is incremented for item 3, and the third icon 740 is removed from the screen 700.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program. Still further, embodiments of the present invention may be conveyed electronically via any medium such as a communication signal carried over a wired or wireless connection and embodiments suitably encompass the same.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A control system for a bulk product weighing system, the control system comprising:
one or more processors;
at least one memory device configured to store product data, the product data comprising information associated with a bulk product and a corresponding bulk product dispenser for the product;
wherein the control system is configured to:
receive, from a sensor associated with the bulk product dispenser, a detection signal indicative of a dispensing event being detected at the bulk product dispenser;
identify the bulk product corresponding to the bulk product dispenser in dependence on the product data;
output a control signal to control a display device of the weighing system to display an indication of the bulk product; and
in dependence on a threshold expiry time period elapsing since detection of the dispensing event, output a control signal to the display device to remove the indication of the bulk product.

2. The control system of claim 1, wherein the control system is configured to:
receive, from a user input device associated with the weighing system, a weighing request for the bulk product;
output a control signal to control a weighing apparatus of the weighing system to weigh the bulk product; and
in dependence on the weighing of the bulk product, output a control signal to the display device to remove the indication of the bulk product.

3. The control system of claim 1, wherein the control system is configured to store a dispense counter indicative of a number of dispensing events for the bulk product detected within a preceding window corresponding to the threshold expiry time period.

4. The control system of claim 3, wherein the control system is configured to:
receive, from the sensor associated with the bulk product dispenser, a further detection signal indicative of a further dispensing event being detected at the bulk product dispenser; and
increment the dispense counter in dependence on receiving the further detection signal.

5. The control system of claim 4, wherein the control system is configured to:
determine whether a time between the detection of the further dispensing event and the detection of a preceding dispensing event at the bulk product dispenser is less than an event threshold time; and
if the time is determined to be less than the event threshold time, suppress the incrementation of the dispense counter.

6. The control system of claim 5, wherein the event threshold time is less than five seconds.

7. The control system of claim 4, wherein the control system is configured to:
start a respective expiry timer in dependence on receiving each further detection signal; and
in dependence on each respective expiry timer reaching the threshold expiry time, decrement the dispense counter.

8. The control system of claim 7, wherein the control system is further configured to decrement the dispense counter in dependence on each weighing of the bulk product by a weighing apparatus of the weighing system.

9. The control system of claim 3, wherein the control system is configured to retain the indication of the bulk product displayed on the display device if the dispense counter is non-zero.

10. The control system of claim 1, wherein:
the product data comprises a loss counter indicative of a number of non-weighed dispense events for the product; and
the control system is configured to increment the loss counter in response to the threshold expiry time period elapsing since detection of the dispensing event without the product being weighed.

11. The control system of claim 1, wherein the display device is a user interface, and wherein the indication of the bulk product comprises an icon for selection of the bulk product at the display device.

12. The control system of claim 1, wherein the threshold expiry time is between 5 minutes and 60 minutes.

13. The control system of claim 1, wherein the control system is configured to receive a selection signal indicative of a user input for selecting the threshold expiry time, and adjust the threshold expiry time in dependence on the selection signal.

14. A bulk product weighing system, the bulk product weighing system comprising:
the control system of claim 1;
a bulk product dispenser arranged to store and dispense a bulk product;
a sensor arranged to detect a dispensing event at the bulk product dispenser;
a weighing apparatus configured to weigh the dispensed bulk product; and
a display device associated with the weighing apparatus arranged to display an indication of the bulk product to a user in dependence on the detection of the dispensing event by the sensor.

15. A computer-implemented method for controlling a bulk product weighing system, the method comprising:
storing product data, the product data comprising information associated with a bulk product and a corresponding bulk product dispenser for the product;
receiving, from a sensor associated with the bulk product dispenser, a detection signal indicative of a dispensing event being detected at the bulk product dispenser;
identifying the bulk product corresponding to the bulk product dispenser in dependence on the product data;
controlling a display device of the weighing system to display an indication of the bulk product; and
in dependence on a threshold expiry time period elapsing since detection of the dispensing event, controlling the display device to remove the indication of the bulk product.
